(19) United States
(12) Patent Application Publication
(10) Pub. No.: US 2010/0225835 A1
(43) Pub. Date: Sep. 9, 2010

(54) POLARIZER BINDING STRUCTURE AND ITS STEREO DISPLAY DEVICE

(76) Inventor: Chia-Ling Lin, Kaohsiung County (TW)

Correspondence Address: NORTH AMERICA INTELLECTUAL PROPERTY CORPORATION, P.O. BOX 506, MERRIFIELD, VA, 22116, US

(21) Appl. No.: 12/436,795

(22) Filed: May 7, 2009

(30) Foreign Application Priority Data
Mar. 6, 2009 (TW) 098203481

(51) Int. Cl. G02F 1/1335; G02B 5/30

(52) U.S. Cl. 349/15; 359/485

(57) ABSTRACT

The present invention relates to a polarizer binding structure and its stereo display device. The polarizer binding structure includes a polarizer and an adhesive pattern layer having a plurality of gaps and the adhesive pattern layer deposed on a surface of the polarizer. The stereo display device of the polarizer binding structure includes a polarizer binding structure deposed between a first liquid crystal panel and a second liquid crystal panel. The polarizer binding structure has an adhesive pattern layer, which has a plurality of gaps and a polarizer deposed on a surface of the adhesive pattern layer, wherein the adhesive pattern layer is bound to the first liquid crystal panel and the polarizer is bound to a surface of the second liquid panel. Furthermore, a backlight module deposed toward the other surface of the second liquid panel. The present invention economizes the cost of the vacuum assembly process.

### BACKGROUND OF THE INVENTION

1. Field of the Invention

The present invention relates to a polarizer structure and its stereo display device, more particular to a polarizer binding structure and its stereo display device, which is used for the area of combining a first liquid crystal panel with a second liquid crystal panel.

2. Description of Related Art

A manufacturing method of a stereo display device 1 of the prior art is shown in FIG. 1 to FIG. 3. First, a polarizer 10 is bound to an upper surface of a first liquid crystal panel 12 by a first adhesive layer 11. Also, a second polarizer 13 is bound to an upper surface of a second liquid crystal panel 15 by a second adhesive layer 14. Furthermore, a third polarizer 17 is bound to an under surface of the second liquid crystal panel 15 by a third adhesive layer 16 (as shown in FIG. 1). Second, a sealant 18 is bound to edges of an under surface of the first liquid crystal panel 12 and edges of the upper surface of the second liquid crystal panel 15 and then the sealant 18 is hardened by ultraviolet. Hence, the first liquid crystal panel 12 is bound and fixed to the second liquid crystal panel 15 (as shown in FIG. 2). Thirdly, a backlight module 19 is deposed under the third polarizer 17 and then the stereo display device 1 is finished (as shown in FIG. 3). The process of ultraviolet irradiating the sealant must be used, so as to increase the cost of the sealant, ultraviolet equipment. Also, it spends much manufacturing time.

A manufacturing method of a stereo display device 2 of the prior art is shown in FIG. 4 to FIG. 6. It doesn't use the sealant to bind a first liquid crystal panel 22 and a second liquid crystal panel 25. First, a polarizer 20 is bound to an upper surface of a first liquid crystal panel 22 by a first adhesive layer 21. Also, a second polarizer 23 is bound to an upper surface of a second liquid crystal panel 25 by a second adhesive layer 24. A fourth adhesive layer 28 is spread on an upper surface of the second polarizer 23. Furthermore, a third polarizer 27 is bound to an under surface of the second liquid crystal panel 25 by a third adhesive layer 26 (as shown in FIG. 4). When the fourth adhesive layer 28 is bound to the first liquid crystal panel 22, the air is between the fourth adhesive layer 28 and the first liquid crystal panel 22 to form bubbles. Hence, the vacuum assembly process must be used. When the fourth adhesive layer 28 is bound to the first liquid crystal panel 22, the surrounding air is excluded to form a vacuum condition in the vacuum assembly process. Hence, the first liquid crystal panel 22 is bound and fixed to the second liquid crystal panel 25 precisely and bias shift phenomenon doesn't happen (as shown in FIG. 5). Then, a backlight module 29 is deposed under the third polarizer 27 and then the stereo display device 2 is finished (as shown in FIG. 6). Because the manufacturing method of the stereo display device 2 must use the vacuum assembly process, the cost of the equipment of the vacuum assembly process is increased and manufacturing time of the stereo display device is longer. According to above prior art being improved, the present invention provides a polarizer binding structure and its stereo display device. It improves the disadvantages of increasing the cost of the sealant, ultraviolet equipment, vacuum assembly process equipment and the manufacturing time.

### SUMMARY OF THE INVENTION

The main objection of the present invention is to provide a polarizer binding structure and its stereo display device, which economizes the cost of sealant and ultraviolet equipment and it also reduces the manufacturing time of the stereo display device.

The other objection of the present invention is to provide a polarizer binding structure and its stereo display device, which economizes the cost of the equipment of the vacuum assembly process.

The present invention provides a polarizer binding structure and its stereo display device. The polarizer binding structure, comprising: a polarizer; and an adhesive pattern layer having a plurality of gaps and the adhesive pattern layer deposed on a surface of the polarizer. The stereo display device of polarizer binding structure, comprising: a first liquid crystal panel; a second liquid crystal panel, deposed toward a surface of the first liquid crystal panel; a polarizer binding structure deposed between the first liquid crystal panel and the second liquid crystal panel, the polarizer binding structure having an adhesive pattern layer and a polarizer deposed on a surface of the adhesive pattern layer, the adhesive pattern layer having a plurality of gaps, wherein the adhesive pattern layer is bound to a surface of the first liquid crystal panel and the polarizer is bound to a surface of the second liquid crystal panel; and a backlight module deposed on the other surface of the second liquid crystal panel.

In order to make the aforementioned objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiment of the invention and together with the description, serve to explain the principles of the invention.

FIG. 1 is a manufacturing schematic diagram (1) of a stereo display device in the prior art.

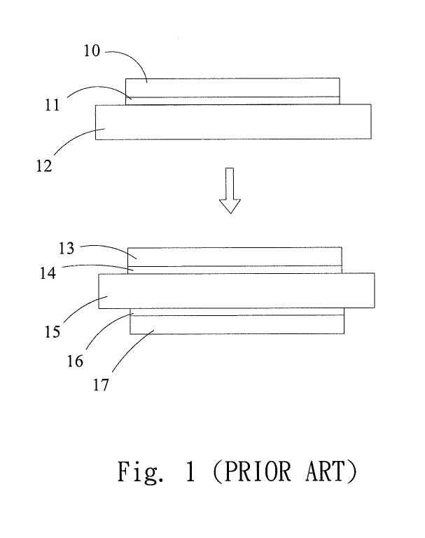

FIG. 2 is a manufacturing schematic diagram (2) of a stereo display device in the prior art.

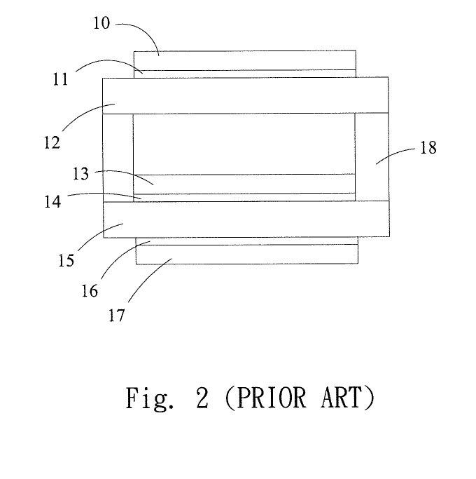

FIG. 3 is a manufacturing schematic diagram (3) of a stereo display device in the prior art.

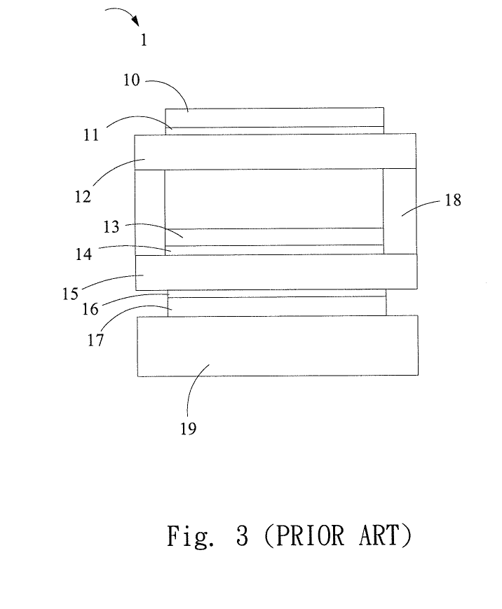

FIG. 4 is the other manufacturing schematic diagram (1) of a stereo display device in the prior art.

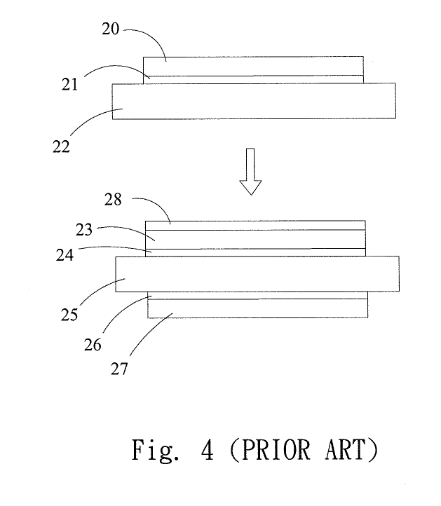

FIG. 5 is the other manufacturing schematic diagram (2) of a stereo display device in the prior art.

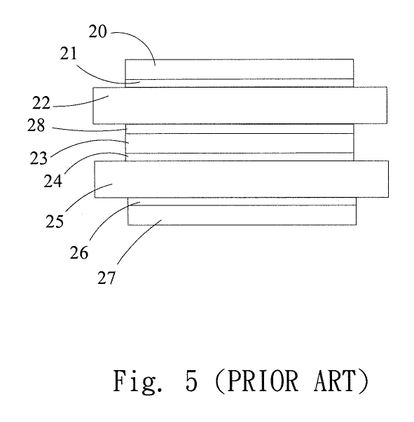

FIG. 6 is the other manufacturing schematic diagram (3) of a stereo display device in the prior art.

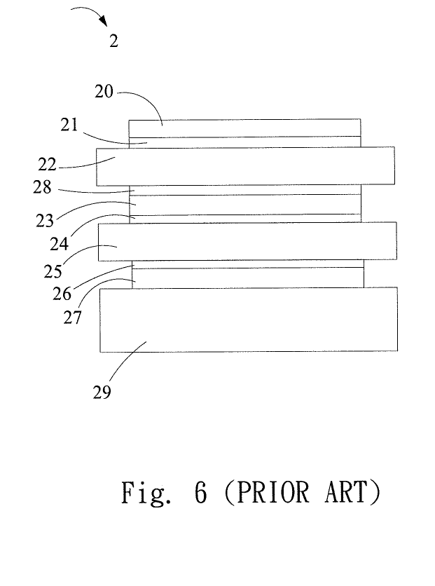

FIG. 7 is a cross-section view of a polarizer binding structure of a preferred embodiment in the present invention.

FIG. 8 is a front view (1) of a polarizer binding structure of a preferred embodiment in the present invention.

FIG. 9 is a front view (2) of a polarizer binding structure of a preferred embodiment in the present invention.

FIG. 10 is a front view (3) of a polarizer binding structure of a preferred embodiment in the present invention.

FIG. 11 is a front view (4) of a polarizer binding structure of a preferred embodiment in the present invention.

FIG. 12 is a front view (5) of a polarizer binding structure of a preferred embodiment in the present invention.

FIG. 13 is a manufacturing schematic diagram (1) of a stereo display device of polarizer binding structure of a preferred embodiment in the present invention.

FIG. 14 is a manufacturing schematic diagram (2) of a stereo display device of polarizer binding structure of a preferred embodiment in the present invention.

FIG. 15 is a manufacturing schematic diagram (3) of a stereo display device of polarizer binding structure of a preferred embodiment in the present invention.

### DESCRIPTION OF PREFERRED EMBODIMENT

### Preferred Embodiment

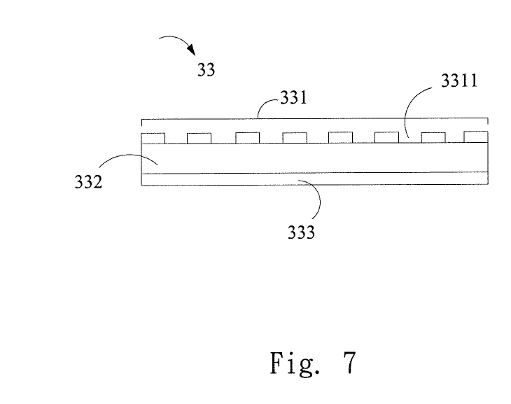

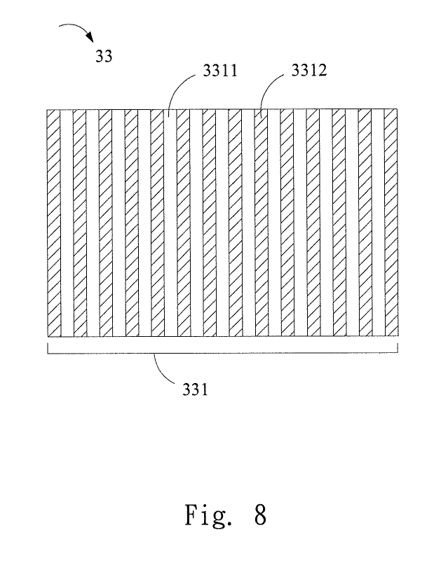

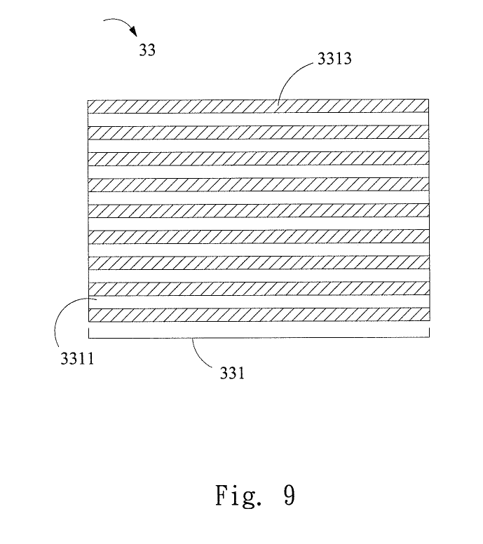

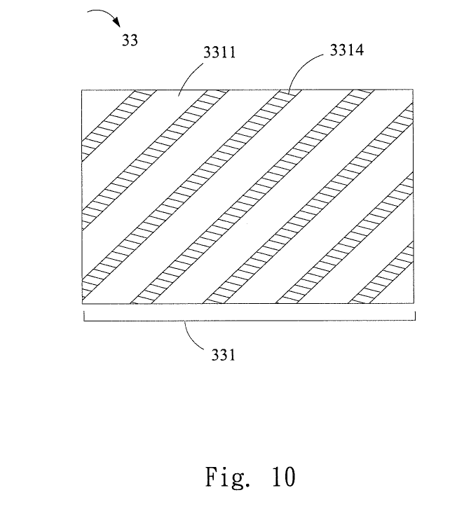

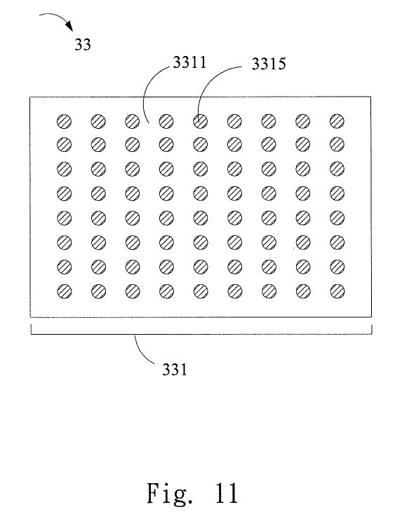

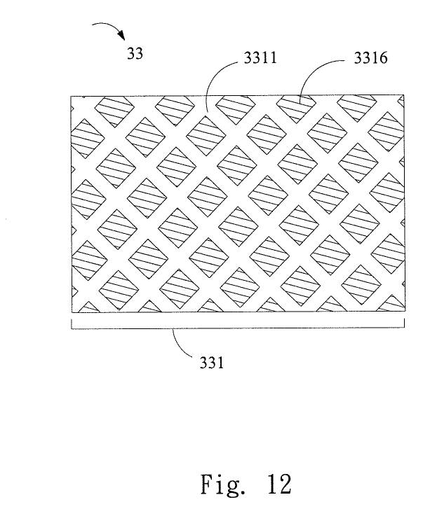

When a stereo display device of polarizer binding structure 3 is manufactured, a polarizer binding structure 33 is provided (as shown in FIG. 7). The polarizer binding structure 33 includes a polarizer 332 and an adhesive pattern layer 331. The adhesive pattern layer 331 has a plurality of gaps 3311 and the adhesive pattern layer 331 is deposed on a surface of the polarizer 332. Furthermore, an adhesive layer 333 is deposed on the other surface of the polarizer 332. The adhesive pattern layer 331 includes a plurality of vertical adhesion strips 3312 and the plurality of gaps 3311 are formed among the plurality of vertical adhesion strips 3312 (as shown in FIG. 8); or includes a plurality of transverse adhesion strips 3313 and the plurality of gaps 3311 are formed among the plurality of transverse adhesion strips 3313 (as shown in FIG. 9); or includes a plurality of oblique adhesion strips 3314 and the plurality of gaps 3311 are formed among the plurality of oblique adhesion strips 3314 (as shown in FIG. 10); or includes a plurality of adhesive points 3315 and the plurality of gaps 3311 are formed among the plurality of adhesive points 3315 (as shown in FIG. 11); or includes a plurality of adhesive lumps 3316 and the plurality of gaps 3311 are formed among the plurality of adhesive lumps 3316 (as shown in FIG. 12).

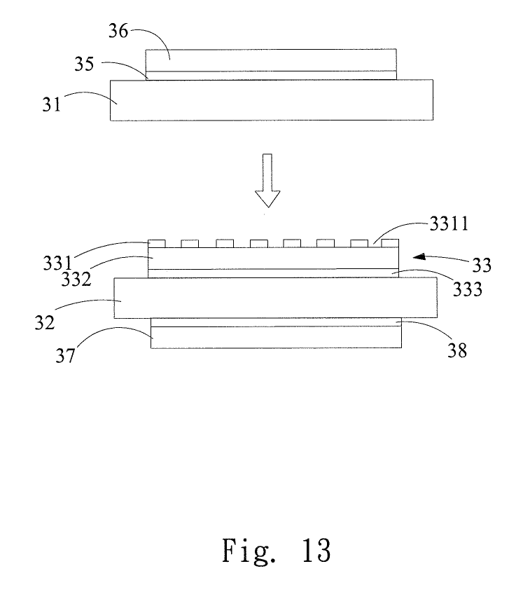

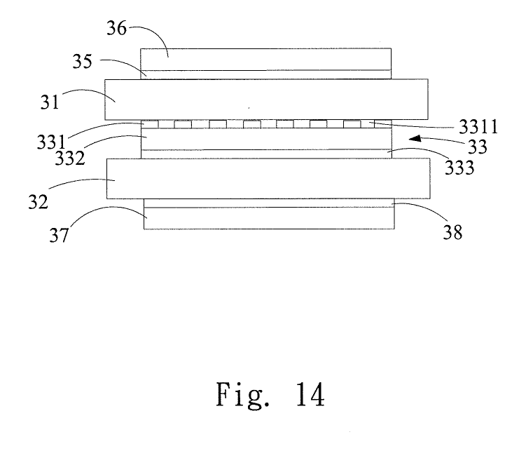

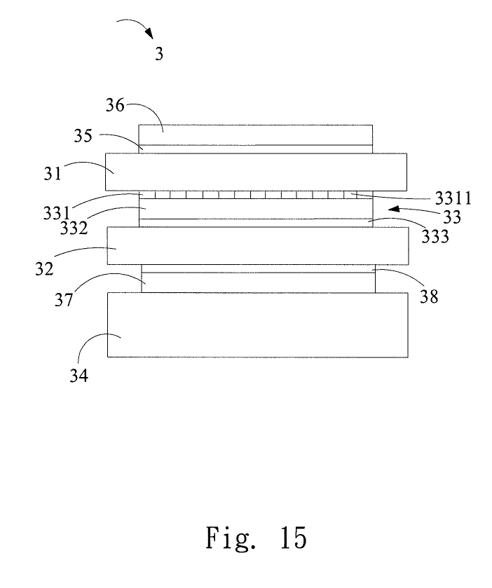

Then, a first polarizer 36 is bound to a first liquid crystal panel 31 by a first adhesive layer 35. The polarizer binding structure 33 is bound to a surface of the second liquid crystal panel 32 by an adhesive layer 333. A second polarizer 37 is bound to the other surface of the second liquid crystal panel 32 by a second adhesive layer 38. Then, it prepares that the adhesive pattern layer 331 is bound and fixed to the first liquid crystal panel 31 (as shown in FIG. 13). When the adhesive pattern layer 331 is bound to the first liquid crystal panel 31, the air between the adhesive pattern layer 331 and the first liquid crystal panel 31 is excluded by the gaps 3311. Hence, the vacuum assembly process is not necessary and the first liquid crystal panel 31 is precisely bound and fixed to the second liquid crystal panel 32 by the polarizer binding structure 33. Also, the bias shift phenomenon doesn't happen (as shown in FIG. 14). Then, a backlight module 34 is deposed under the second polarizer 37. Hence, the stereo display device 3 of polarizer binding structure is finished (as shown in FIG. 15).

The stereo display device of polarizer binding structure 3 (as shown in FIG. 15) includes the first liquid crystal panel 31; the second liquid crystal panel 32 deposed toward a surface of the first liquid crystal panel 31; and the polarizer binding structure 33 deposed between the first liquid crystal panel 31 and the second liquid crystal panel 32. The polarizer binding structure 33 includes the adhesive pattern layer 331. The polarizer 332 is deposed on a surface of the adhesive pattern layer 331. The adhesive pattern layer 331 has a plurality of gaps 3311, wherein the adhesive pattern layer 331 is bound to the surface of the first liquid crystal panel 31 and the polarizer 332 is bound to a surface of the second liquid crystal panel 32. The backlight module 34 is deposed toward the other surface of the second liquid crystal panel 32. The adhesive layer 333 is further deposed between the polarizer 332 and the second liquid crystal panel 32 that makes the polarizer 332 bound to the second liquid crystal panel 32.

The other surface of the first liquid crystal panel 31 is bound to the first polarizer 36 by the first adhesive layer 35. The second polarizer 37 is deposed between the second liquid crystal panel 32 and the backlight module 34. The second polarizer 37 is bound to the other surface of the second liquid crystal panel 32 by the second adhesive layer 38.

According to above mention, the present invention has following advantages:
1. The present invention economizes the cost of sealant and ultraviolet equipment and it also reduces the manufacturing time of the stereo display device.
2. The present invention economizes the cost of the equipment of the vacuum assembly process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A polarizer binding structure, comprising:
a polarizer; and
an adhesive pattern layer having a plurality of gaps and the adhesive pattern layer deposed on a surface of the polarizer.

2. The polarizer binding structure according to the claim 1, further comprising an adhesive layer deposed on the other surface of the polarizer.

3. The polarizer binding structure according to the claim 1, wherein the adhesive pattern layer includes a plurality of vertical adhesion strips and the plurality of gaps are formed among the plurality of vertical adhesion strips.

4. The polarizer binding structure according to the claim 1, wherein the adhesive pattern layer includes a plurality of transverse adhesion strips and the plurality of gaps are formed among the plurality of transverse adhesion strips.

5. The polarizer binding structure according to the claim 1, wherein the adhesive pattern layer includes a plurality of oblique adhesion strips and the plurality of gaps are formed among the plurality of oblique adhesion strips.

6. The polarizer binding structure according to the claim 1, wherein the adhesive pattern layer includes a plurality of adhesive points and the plurality of gaps are formed among the plurality of adhesive points.

7. The polarizer binding structure according to the claim 1, wherein the adhesive pattern layer includes a plurality of adhesive lumps and the plurality of gaps are formed among the plurality of adhesive lumps.

8. A stereo display device of polarizer binding structure, comprising:
a first liquid crystal panel;
a second liquid crystal panel deposed toward a surface of the first liquid crystal panel;
a polarizer binding structure deposed between the first liquid crystal panel and the second liquid crystal panel, the polarizer binding structure having an adhesive pattern layer and a polarizer deposed on a surface of the adhesive pattern layer, the adhesive pattern layer having a plurality of gaps, wherein the adhesive pattern layer is bound to a surface of the first liquid crystal panel and the polarizer is bound to a surface of the second liquid crystal panel; and
a backlight module deposed toward the other surface of the second liquid crystal panel.

9. The stereo display device of polarizer binding structure according to the claim 8, further comprising an adhesive layer between the polarizer and the second liquid crystal panel making the polarizer bound to the second liquid crystal panel.

10. The stereo display device of polarizer binding structure according to the claim 8, wherein the adhesive pattern layer includes a plurality of vertical adhesion strips and the plurality of gaps are formed among the plurality of vertical adhesion strips.

11. The stereo display device of polarizer binding structure according to the claim 8, wherein the adhesive pattern layer includes a plurality of transverse adhesion strips and the plurality of gaps are formed among the plurality of transverse adhesion strips.

12. The stereo display device of polarizer binding structure according to the claim 8, wherein the adhesive pattern layer includes a plurality of oblique adhesion strips and the plurality of gaps are formed among the plurality of oblique adhesion strips.

13. The stereo display device of polarizer binding structure according to the claim 8, wherein the adhesive pattern layer includes a plurality of adhesive points and the plurality of gaps are formed among the plurality of adhesive points.

14. The stereo display device of polarizer binding structure according to the claim 8, wherein the adhesive pattern layer includes a plurality of adhesive lumps and the plurality of gaps are formed among the plurality of adhesive lumps.

15. The stereo display device of polarizer binding structure according to the claim 8, wherein the other surface of the first liquid crystal panel is bound to a first polarizer.

16. The stereo display device of polarizer binding structure according to the claim 8, further comprising a second polarizer between the second liquid crystal panel and the backlight module and the second polarizer bound to the other surface of the second liquid crystal panel.
